(19) United States
(12) Patent Application Publication
(10) Pub. No.: US 2006/0104710 A1
(43) Pub. Date: May 18, 2006

(54) Flexible corner forming spacer

(76) Inventor: Luc Marcel Lafond, ETOBICOKE (CA)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/521,488

(22) PCT Filed: Jul. 18, 2003
(86) PCT No.: PCT/CA03/01091

§ 371 Date: Sep. 15, 2005

(51) Int. Cl. F16B 1/00

(52) U.S. Cl. 403/205

(57) ABSTRACT

A tubular spacer core (50) may be used to manufacture an insulated glass assembly. The core is hollow and has a plurality of bending zones along its length. Each bending zone includes a plurality of circumferential ribs (53). Each rib has sides (57, 59) of unequal length. The ribs reenter and overlap their adjacent ribs when the core is bent along the longitudinal axis of the core. The ribs (53) lock in place to form a sharp corner at the inner edge (52), at the bend. The ribs (53) unfold and expand at the outer edge (54), at the location of the bend. The core (50) may also include a layer of desiccant and a vapor barrier. Adhesive is used to secure the appropriately shaped core between a pair of opposing glass plates, to manufacture an insulated glass assembly.

### FIELD OF THE INVENTION

The present invention relates to a spacer for use in an insulated glass assembly. The invention also relates to an insulated glass assembly incorporating such a spacer.

### BACKGROUND OF THE INVENTION

Insulated glass assemblies known in the art incorporate various spacer bodies made of either metallic or non metallic materials. Often, non metallic materials such as thermoplastics are used to construct the spacer bodies. The bodies may be shaped or formed by extrusion or other known methods.

The spacers may be used in association with other components in the insulated glass assemblies. The other components may include a vapor barrier to inhibit vapor entry into the interior of the assembly and a desiccant to inhibit the formation of moisture droplets within the interior of the insulated glass assembly. Often, the spacer and other components are secured to glass layers within the assembly by application of an adhesive.

Typically, the glass assemblies are manufactured for installation into square or rectangular openings. Custom shaped glass assemblies of other shapes may also be provided. However, the spacers of the prior art are difficult to shape into sharp corners. There is a tendency for such earlier spacers to buckle, deform or resist being shaped into sharp angled corners.

If the spacers are not properly fitted into the corners of the assemblies, the aesthetics and performance of the glass assemblies may be compromised. Indeed, there is a tendency for the prior art spacers to form a rounded interior edge that compromises the aesthetic qualities or appearance of the insulative glass assemblies. There may also be an increased risk of vapor entry into the interior of the assembly if the spacer is deformed or poorly fitted, which could lead to water droplets forming within the assembly, and a compromise in the thermal insulative properties of the glass assemblies.

To overcome this tendency, prior art manufacturing techniques typically involve cutting the spacer at the corners so that the spacer assemblies may be shaped to tightly fit into the sharp corners of the glass assemblies. Additional adhesive or other fillers may be applied adjacent the cuts, or within the spaces formed by the cuts, to protect against vapor penetration and inhibit reduced thermal insulative performance within the cut zone. In the prior art, a hot melt or other sealant material is often used to fill the cut zone.

The steps of cutting and subsequently sealing the corner zones of the prior art spacer cores are typically cost and labor intensive. Irregular or imprecise cuts also tend to result in increased spoilage rates during production of the assemblies, resulting in higher overall production costs.

In the unrelated field of drinking straw manufacture, U.S. Pat. No. 3,409,224 discloses a hollow drinking tube having a generally circular cross section. The drinking tube is provided with a single flexible zone between the two ends of the hollow drinking straw. The flexible zone extends along a small portion of the length of the drinking tube.

### SUMMARY OF THE INVENTION

The spacer of the present invention is a hollow cored spacer made from a flexible material that is also resilient against excessive deformation. The spacer may be extruded or otherwise formed into a tubular structure from a thermoplastic material. The material of manufacture is typically selected to resist ultra violet deterioration and thermally induced deformation within the expected range of operating or installation conditions.

The hollow cored spacer may be filled with desiccant and other components within the hollow interior. The desiccant may be impregnated within a matrix applied to one or more interior surfaces of the hollow core. By way of further example, a laminated vapor barrier layer may be applied to the exterior walls or to the interior walls to inhibit migration of moisture across the interior of the spacer. In other instances, the other components may be applied in different locations, or may be absent in some applications.

The tubular spacer has a corrugated outer surface within the flexible corner zones intended to fit within the corners of the insulated glass assemblies. In some instances, that corrugated surface may be limited to the corner zones. However, in the preferred embodiment, the corrugated surface will extend along the entire length of the spacer core. In either case, there will be sufficient corrugated surface along the length of a tubular core so that the core may be shaped to conform to the corners of an insulated glass assembly. Typically, the glass assembly will have four 90 degree corners. Consequently, the tubular spacer will have sufficient corrugated surface along its length to provide interlocking bend zones for each of the four corners.

The corrugated outer surface is made up of parallel circumferential folds or ribs extending across the longitudinal axis of the spacer. Each parallel fold or rib has one relatively short wall portion connected along a peak ridge to a relatively longer wall portion. The folds or ribs are formed so that the outer surface is defined by an alternating sequence of short circumferential wall portions followed by the longer circumferential wall portions.

Typically the spacer core is generally square or rectangular when viewed in cross-section. Although the spacer may be formed into other shapes (where, for example, only two opposing walls are parallel), the generally square or rectangular shapes are preferred for most insulated glass assemblies. Persons skilled in the art will appreciate that generally square or rectangular shaped spacers will be preferred for a variety of reasons. For example, the spacer core will typically have a pair of parallel side walls that will be bonded to the glass layers by applying layers of adhesive between the side walls and the glass layers. Another pair of parallel outer walls will be provided so that one wall will face inwardly toward the interior of the insulated glass assembly. The second wall will generally face outwardly away from the interior of the insulated glass assembly.

When viewed in cross-section, the outer corners of the spacer are slightly rounded or radiused to improve performance when the spacer is shaped to fit into the insulated glass assemblies.

The size of the folds or ribs may be optimized for each particular application so that the spacer, with its particular outer dimensions and outer wall thicknesses, will provide the best fit for the particular corner or edge for which it will be fitted in the insulated glass assembly.

When the tubular spacer core is bent across its longitudinal axis, the circumferential ribs tend to lock into place. Along one side of the tubular core, the adjacent ribs will reenter and overlap neighboring ribs along the inner radius of the corner formed within the bent zone of the core. The outer radius portion of the corner will form a different configuration as the adjacent folds or ribs will tend to unfold and stretch across a longer radius within the bend zone.

The tubular core will tend to lock into place when bent This feature will also enhance the formation of sharp corners within the resulting glass assemblies. Once locked into place, the ribs will tend to retain their sharp cornered shape over the expected life of the glass assembly. The provision of the circumferential folds or ribs will also inhibit irregular deformations and buckling zones within the corner formed by the bent spacer core.

It will be appreciated that this sharp cornered appearance will be achievable without the need to cut or otherwise destroy the integrity of the tubular core.

In one aspect, the invention is an elongated tubular spacer core for use in an insulated glass assembly. The core may have a plurality of bending zones between the ends of the core. Each bending zone comprises a plurality of circumferential ribs and each rib has sides of unequal length. The ribs are reentrant and overlap when the core is bent along a longitudinal axis of the core.

The core is preferably either generally square or rectangular in cross section. The core is defined by two pairs of opposing parallel walls. A radiused corner is provided between each pair of adjacent walls.

In some applications, the walls of the core will form a closed hollow tube. In other instances, it may be preferable to have a core which is a generally U-shaped open channel.

The core may also include one or more composite elements such as a desiccant and a vapor barrier. The desiccant may be provided within the interior of the hollow core.

In many instances, the core will be manufactured as an elongated hollow tube of sufficient length to provide a plurality of spacer cores that may be cut into appropriate lengths so that each length may be installed in an insulated glass assembly.

In many instances, the ribs will be identical and will extend around the entire perimeter defined by the tube. Each rib will have sides of unequal length. A first leading side will be shorter than a second trailing side of the rib. When the tubular core is bent, the ribs will fold along a first side of the tube and the ribs will expand along a second opposite side of the tube.

In another aspect, the invention is an elongated tubular spacer to be installed in an insulated glass assembly. The tubular spacer comprises an elongated tubular core that defined a plurality of ribs extending about the periphery of the tubular core. Each rib has sides of unequal length. The ribs fold and overlap to lock in place when the core is bent along a longitudinal axis of the core. The tubular spacer may include a desiccant applied within the interior of the tubular core. The spacer may also include a vapor barrier provided along the length of the tubular core.

In yet another aspect, the invention is an insulated glass assembly that defines a plurality of angular corners. The assembly comprises an elongated tubular spacer, a vapor barrier provided along the length of the tubular core, a pair of opposing glass plates, and an adhesive applied to secure the spacer between the pair of opposing glass plates. The spacer includes an elongated tubular core defining a plurality of ribs extending about the periphery of the tubular core. Each rib has sides of unequal length. The ribs have been folded and overlap where the core has been bent along a longitudinal axis of the core to fit within the angular corners of the assembly. A desiccant may be provided within the interior of the tubular core.

Other aspects of the invention will be apparent upon a further review of the appended drawings and following description of the invention.

### BRIEF DESCRIPTION OF THE DRAWINGS

FIG. 1A is an end view, in perspective, of a prior art spacer core that has been cut within a corner zone of the spacer core.

FIG. 1B is a schematic representation of the spacer core shown in FIG. 1A, with a sealant plug applied to the cut corner zone.

FIG. 2 is a representation in perspective view of another spacer core of the prior art.

FIG. 3 is a partial sectional view of one embodiment of the present invention.

FIG. 4 is a cross sectional view of the embodiment of FIG. 3 shown within an insulated glass assembly.

FIG. 5 is a top view of a section of another embodiment of the spacer core of the present invention.

FIG. 6 is a perspective view of a partial section of a flexible portion of the hollow spacer core of the present invention.

FIG. 7 is a partial sectional front view, along lines A-A′ of the spacer core shown in FIG. 6.

FIG. 8 is a schematic representation of a folded corner segment of another hollow spacer core of the present invention.

FIG. 9A is a schematic representation of the steps of manufacture of one embodiment of the present invention.

FIG. 9B is a cross sectional view of an assembled version of the embodiment shown in FIG. 9A.

FIG. 10 is a perspective view of another embodiment of a hollow spacer core of the present invention, shown in an extended linear arrangement.

FIG. 11 is a perspective view of the hollow core spacer, of FIG. 10, shown in an assembled, interlocked arrangement.

FIG. 12 is a perspective view of another embodiment of a hollow core spacer of the present invention.

### DETAILED DESCRIPTION OF THE INVENTION

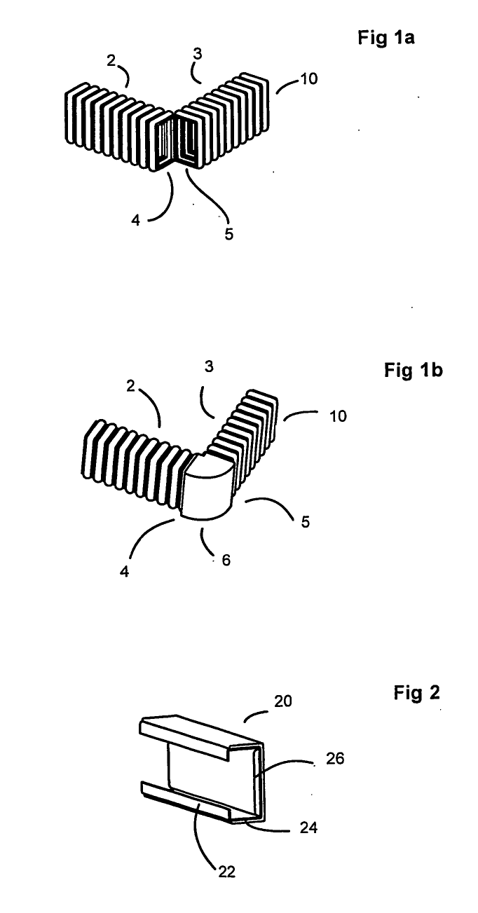

FIGS. 1 and 1B show a schematic representation of a prior art spacer core 10 that has been cut to form two connected sections 2, 3. Some of the prior art spacers may have a hollow core. In this prior art example, the hollow core spacer is shaped with an undulating surface having alternating rounded peaks and valleys. Although, the spacer will bend when installed at the corners of an insulated glass assembly, the corner zone of the spacer tends to form a rounded inner corner if left uncut, and will not interlock to form a sharp corner. Some deformation and buckling of the prior art core may also occur adjacent the bent zone of the hollow core. To compensate for this tendency, the prior art spacer is cut to form cut edges 4, 5. The openings to the interior of the hollow core are then sealed with a hot melt or sealant 6 to prevent vapor entry into the interior of the core.

FIG. 2 is a cross sectional view, shown in perspective, of another prior art spacer core 20. The core 20 is a flat walled open channel. The channel is formed from an elongated, thin walled sheet of resilient material 22 to provide a hollow, open core. The interior of the core is partially filled with a desiccant matrix 26 to absorb excess moisture that may enter the interior of an assembled insulated glass assembly (not shown). A hot melt 24 is applied to secure the spacer core between two sheets of glass in the glass assembly (not shown).

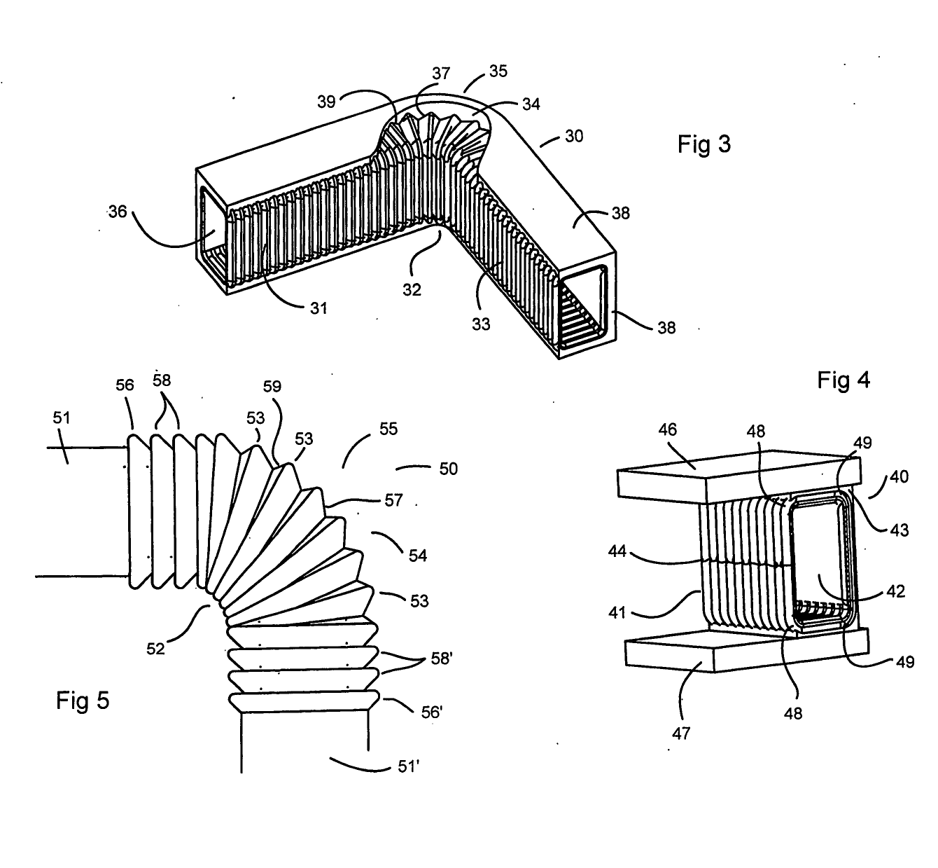

FIG. 3 shows a partial sectional view, in perspective, of an embodiment of the present invention. A spacer core assembly 30 has a corrugated, accordion-like wall 34 made of similar ribs 33 which form circumferential rings about the longitudinal axis of the hollow core 31. The spacer core 31 is formed into a relatively straight, corrugated hollow tube having a plurality of ribs along its length. Each rib is made up of a short leading wall 39 connected to a longer trailing wall 37. The peak and valley edges of each rib 33 form pivotal or hinge-like edges for reentrant interlocking along inner corner 32 and expansion along outer corner 35 of the spacer core 31. The hollow inner channel of the spacer may be partially filled with a desiccant matrix 36 along the length of the hollow core 31. Hot melt 38 is applied to the outer walls of the spacer core 31 to secure the core to the glass panels of a glass assembly and to seal the insulated glass assembly unit (not shown).

In some embodiments, it may be desirable to use a relatively thin sheet of metallic material as the material for construction of the spacer core. For example, the material may be a metallic foil. It will be preferable that the sheet be sufficiently thin to allow bending of the manufactured core and interlocking of the ribs when the core is bent and fitted into the corner of an insulated glass assembly. In other instances, the material of manufacture may be a thermoplastic material.

FIG. 4 shows a cross sectional view of an insulated glass assembly 40 in which the spacer core 41 of the present invention is installed between opposing sheets of glass 46, 47. The spacer core 41 is shown with hot melt or adhesive 43 securing the core to the glass panels. The core 41 is made of a relatively thin outer wall surrounding a hollow center, partially filled with a desiccant matrix 42. A vapor barrier layer (not shown) may be applied either to an inner wall or an outer wall of the spacer core. For example, the vapor barrier may be a metallic film or a metalized film applied to a selected surface of the core. Persons skilled in the art will appreciate that the design and location of the vapor barrier may be adapted to the particular design requirements of the desired insulated glass assembly being manufactured.

The core wall is slightly rounded or radiused at corners 48, 49 to enhance the interlocking qualities of the circumferential ribs of the core wall and to reduce undesirable buckling within the bending zone.

The core 41 is also shown with a seam weld 44 running along the length of the spacer core 41. In the particular core represented in this embodiment, the seam 44 results when the longitudinal edges of an elongated, closed channel are welded together to seal the hollow center of the core. For example, if the core is formed by rolling and bending a flexible but resilient a narrow band of material into a substantially closed channel, it will often be preferable to weld the opposing edges of the channel together. The weld will inhibit undesired separation of the walls of the hollow core and will tend to enhance performance of the sealed hollow core. The seam will also tend to reinforce the spacer core against distortion when the core is bent and filled into the corner of an insulated glass assembly. In some embodiments (which are not shown), it may be desirable to have the hollow core form an open, U-shaped channel in which the opposing edges of the channel have not been welded together.

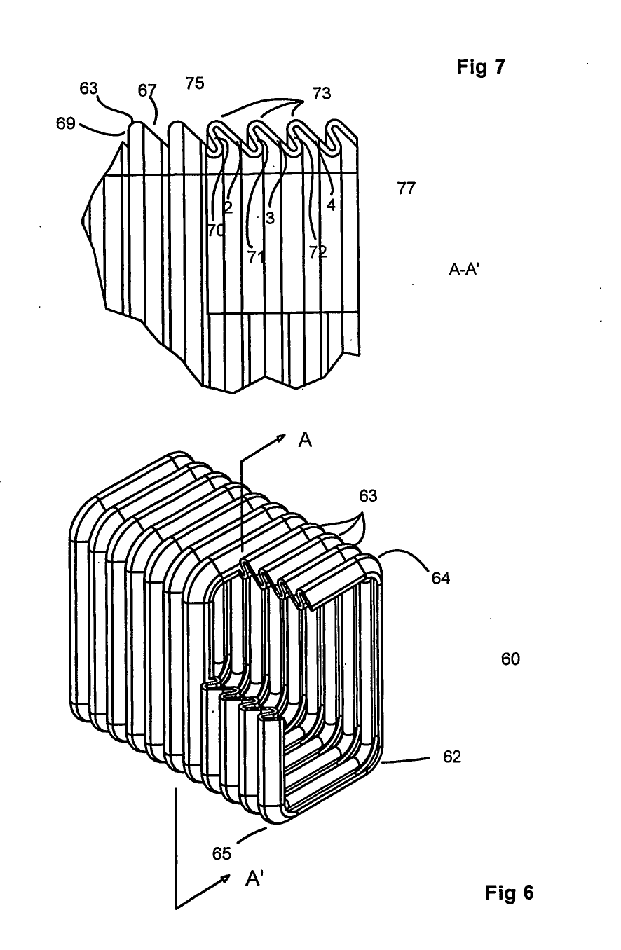

FIG. 5 illustrates another embodiment of the present invention. A hollow core spacer 50 comprises three (3) segments 51, 55 and 51′. Hollow core segments 51 and 51′ are generally rectangular or square in cross section and do not have any accordion-like circumferential rings. Hollow core segment 55 is banded by accordion-like circumferential ribs 53 which form circumferential rings about the longitudinal axis of the hollow core 50. The spacer core 50 is formed into a relatively straight, hollow tube having a plurality of corrugated, ribbed segments 55 along its length. Each rib 53 is made up of a short leading wall 59 connected to a longer trailing wall 57. The peak and valley edges of each rib 53 form pivotal or hinge-like edges for reentrant interlocking along inner corner 52 and expansion along outer corner 54 of the spacer core 50. The hollow inner channel of the spacer may be partially filled with a desiccant matrix (not shown) along the length of the hollow core 50. Hot melt (not shown) may be applied to the outer walls of the spacer core 50 to secure the core to the glass panels of a glass assembly and to seal the insulated glass assembly unit (not shown).

It will be understood that the accordion-like circumferential ribs 53 within segment 55 are shown in an unfolded or extended orientation, along outer corner 54. The ribs 53 are fanned out along outer corner 54. Along inner corner 52, ribs 53 are further compressed, in the interlocked position, to form a shortened inner radiused corner 52 relative to outer corner 54.

In each rib, it is preferable that one side of the rib (a leading wall of the rib) be shorter than the following side (a trailing wall of the rib). The adjacent ribs 53 in the bending zone may be unfolded along the outer corner 54. The unfolding of the ribs 53 along the outer corner will tend to unlock the outer edges of ribs 53 situated within the bending zone.

Ribs 56, 58 and 56′ and 58′ located along the terminal portions of segment 55 are shown in their interlocked positions. Ribs 56, 58, 56′ and 58′ have not been unfolded during formation of the radiused corner within the bend zone of the spacer core 50. In this embodiment, a surplus number of interlocking ribs have been provided (for example ribs 56, 58, 56′ and 58′) such that the surplus ribs were not required to shape the core segment into the illustrated 90 degree elbow. However, in other configurations, (for example, where the angle of the inner corner is less than 90 degrees) more ribs will be unlocked along the outer corner of the bend zone.

In other instances, the surplus ribs may provide manual operators with additional opportunities to fit pre-formed spacer core segments into off-size corners. For example, if an operator finds that a particular insulated glass assembly is slightly irregular in shape, it may be necessary to unfold a different selection of ribs within the segment 55, to form the 90 degree corner.

With reference to FIGS. 6 and 7, a portion of another embodiment of the present flexible spacer core is shown. FIG. 6 is a partial sectional view, in perspective, of a flexible core segment 60 with a cut away section removed to show the internal features of the circumferential ribs 63 which extend about the longitudinal axis of the core segment 60. The core segment 60 is generally square in cross section with four slightly rounded corners, of which three rounded corners 64, 62 and 65 are shown. The ribs 63 are shown in their initial linear arrangement, before the segment is shaped to form a radiused corner by bending the segment.

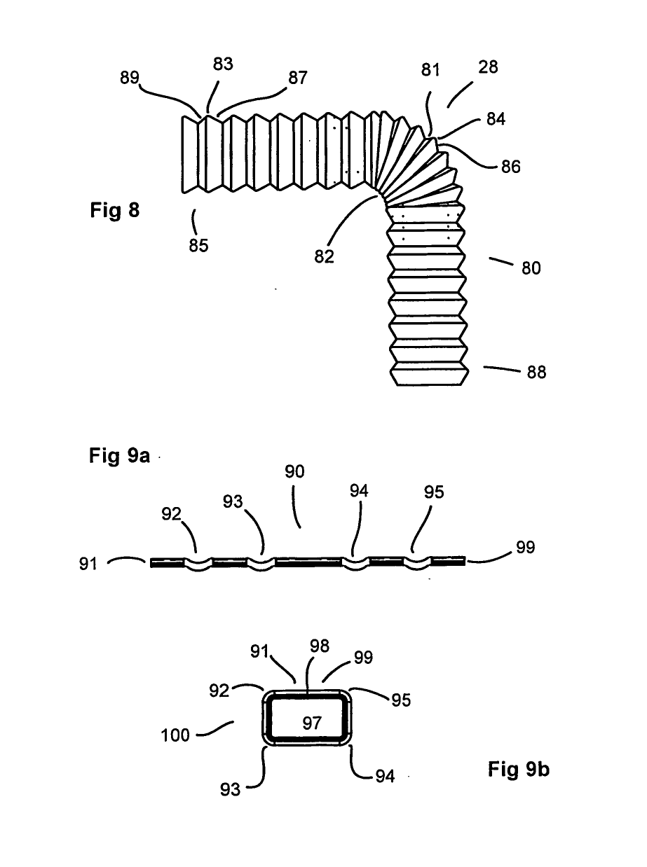

In this embodiment, the ribs 63 are shown in a prefolded, interlocked position (as distinguished from the variant shown in FIG. 8 further below). In segment 60 of FIG. 6, the ribs 63 will be bent at a selected location, so that the rib ends at the inner radiused corner will be further compressed and will remain in their interlocked position. However, a number of the rib ends at the outer radiused corner of the bent portion will be unfolded and unlocked to form an outer corner having a longer radius relative to the inner corner. The bent corner of the shaped core will tend to retain its new shape since the rib ends at the inner corner will be compressed in their interlocked position.

FIG. 7 shows a partial view of a section of the core segment 60 along section line A-A. The bottom rib end 63 is shown in interlocked position, with leading edge 69 retracted inwardly from the outer surface of the core segment. Trailing edge 67 is longer than leading edge 69 and edge 67 slopes inwardly toward the center of the core segment.

Above section line A-A, the inner surface of the core segment 60 is shown. Rib 73 projects outwardly from the central, longitudinal axis of the core segment 60. Inner valleys 70, 71, 72 correspond to the innermost projections of circumferential ribs 73. By way of example, when the core segment 60 is bent inwardly along the back wall 75, ribs 73 engage and interlock with trailing edges 2, 3, 4 of the adjacent ribs, to form the desired radiused corner. If in an alternative arrangement, the segment 60 is bent inwardly along the opposing front wall, ribs 73 along back wall 75 are unfolded, to fan outwardly to form an expanded outer curve about the opposing inner corner (not shown).

FIG. 8 illustrates an alternative embodiment of a bendable zone of an elongated hollow tubular core 80. The bendable zone comprises a number of circumferential ribs 83 which have a short leading edge 89 followed by a longer trailing edge 87. The bendable zone is initially formed so that all of the rings in the bendable zone form a generally straight, linear segment (not shown). Initially all of the rings in this embodiment are extended in an unfolded and unlocked orientation, forming a straight bendable zone segment. However, when a selected number of ribs 84 are bent inwardly about corner 82, the rib ends at corner 82 are folded inwardly, and are interlocked to provide a 90 degree radiused inner corner 82 which is significantly less than the outer radiused corner 28. Although the ribs 84 are urged to remain within the folded, interlocked position at the inner corner 82, those ribs are not necessarily folded or interlocked along the outer corner 28. Similarly, in this embodiment, the other ribs which have not been bent to form the radiused corner 82 also remain unaffected and are not folded inwardly or interlocked.

FIGS. 9A, 9B show a possible alternative for manufacturing hollow core spacer 100 from a flat sheet 90 of resilient, flexible material with suitable performance qualities for the particular application. The sheet of material 90 may be embossed with preformed, circumferential re-entrant ribs (not shown) by rolling and then bending the embossed sheet into a substantially enclosed hollow channel 100. The sheet 90 is also embossed with preformed rounded corners 92, 93, 94 and 95 positioned between lateral edges 91, 99 for use in forming the final core. After the substantially enclosed core 100 is roll formed, the opposing edges 91, 99 of the shaped sheet are welded together along weld line 98.

Interior space 97 may be filled with a desiccant matrix, vapor barrier or other components of the final core assembly.

The methods of manufacture represented in FIGS. 9A and 9B are not meant to represent the preferred method of manufacture. Indeed, the method of manufacturing the hollow core spacer of the present invention is not an essential requirement. The methods represented herein have been explained for purposes of illustration only. Other methods of manufacture may be employed. By way of further example, if the selected material of manufacture is a thermoplastic material, the material may be formed into the desired core by extrusion or other methods suitable for forming hollow plastic tubular structures.

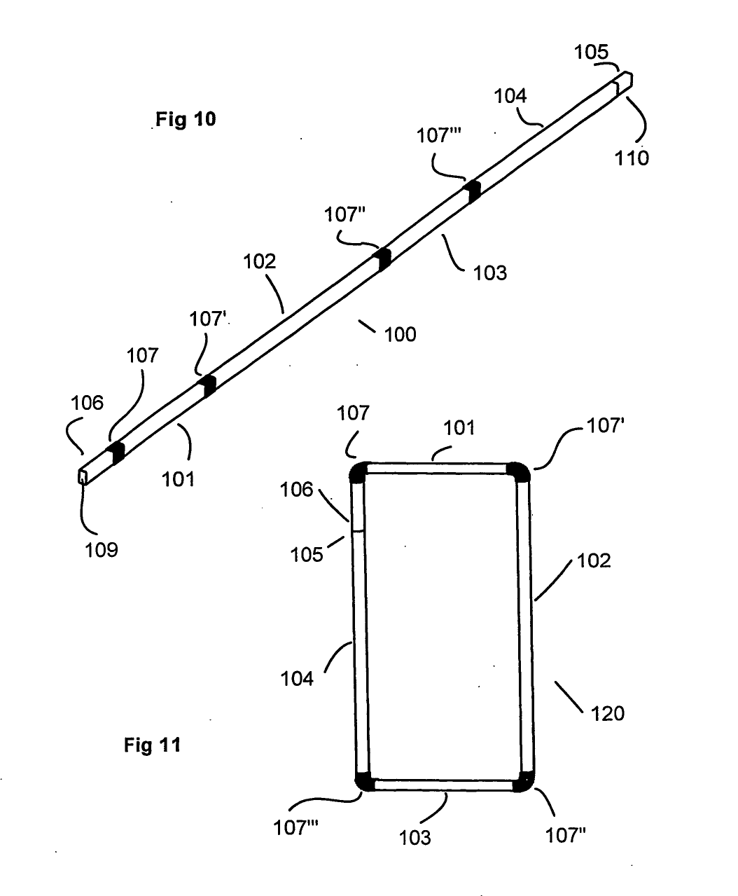

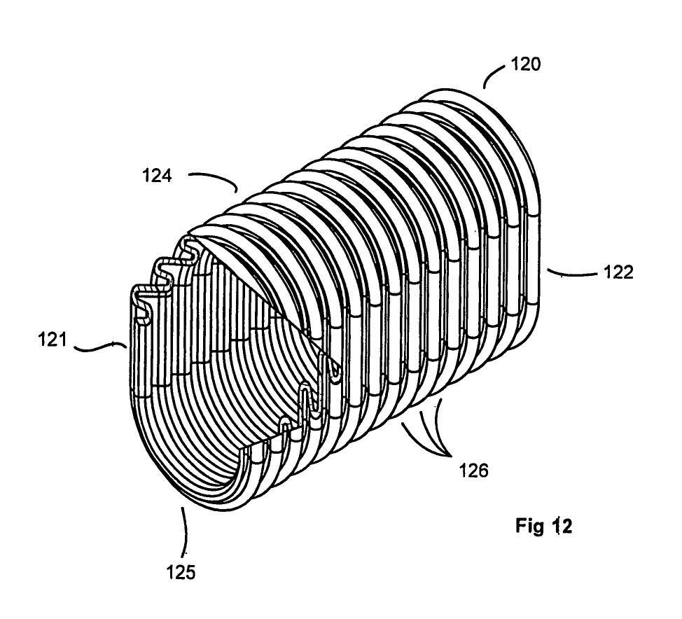

FIGS. 10 and 11 show a preferred configuration for an alternate, partially corrugated hollow spacer core. The spacer core may be either substantially square or rectangular when viewed in cross section. Generally, although not necessarily, it will be preferred that the hollow spacer core will have relatively flat outer walls to simplify the application of additional layers of adhesives, sealants, desiccants, vapor barriers, or other component layers desired for added performance of the final spacer product.

FIG. 10 illustrates an example of a linear hollow, tubular core 100 that incorporates alternating rigid zones 106, 101, 102, 103 and 104 and bending zones 107, 107′, 107″, and 107′″. In this embodiment, each bendable zone is provided with a predetermined number of interlocking circumferential ribs which extend about the longitudinal axis of the tubular core 100. In this example, four bendable zones are provided. In other embodiments, the number of bendable zones, their location, and the relative sizes of the bendable and rigid zones will vary according to the shape and dimensions of the final insulated glass assembly to be fitted with the tubular core. The number of bendable zones provided in a core segment may be more than is necessary for the final assembly.

In FIG. 10, end 105 of core 100 is provided with an elongated tongue 110 which interlocks with opening 109 provided at opposite end 105 of core 100. In FIG. 11, a shaped core 120 is shown forming a closed rectangular shape with interlocked ends 105 and 106 in abutting relation and with all four bendable zones 107, 107′, 107″, and 107′″ having been shaped to provide four 90 degree corners.

The tongue 110 may take the form of an insert, similar to a dowel-like insert to engage and connect opposing ends 105, 106. In other instances, tongue 110 may be formed by remolding, compressing or stretching end 105 to interlock with opening 109 at opposing end 106.

Although this particular example does not show the other components of an insulated glass assembly, which may include hot melt adhesives, vapor barriers, desiccants or components, those other elements may be provided as necessary or desirable for a particular glass assembly installation.

FIG. 12 shows another example of the present invention in which the hollow core spacer 120 is generally oval in cross-section. The spacer core 120 has a pair of opposing, parallel, flat side walls 121, 122, and a pair of opposing, rounded end walls 124, 125. The hollow core 120 has re-entrant ribs 126 extending about the periphery of the core 120. The core may be bent across its longitudinal axis so that the ribs 126 on the inner radius are folded inwardly, to interlock and form a relatively sharp 90 degree corner, whereas the ribs 126 on the outer radius are unfolded and extended, to form a radiused corner.

It will be appreciated that one of the important features of the present invention is found in the configuration of the ribs formed on the spacer core. The ribs are preferably substantially identical, and define parallel rings across the length of the tubular core. In most instances, the ribs will span the entire circumference of the spacer core. In each rib, it is preferable that one side of the rib (a leading wall of the rib) will be shorter than the following side (a trailing wall of the rib). The flexible nature of the material of construction will allow the adjacent ribs in the bending zone to be folded into an overlapping position (such as described in reference to FIG. 8). The folding will tend to interlock the ribs along the inner zone of the bend zone. The ribs will tend to fan out or separate slightly along the outer zone of the bend zone.

It will be preferable that each section of manufactured core will provide a plurality of bending zones in which a single piece of spacer core may be bent to fit a corresponding number of corners within an insulated glass assembly. The plurality of bending zones may be provided in a variety of different ways. By way of example, the spacer core may be manufactured so that discreet sections of the tubular structure are corrugated with the circumferential ribs described herein. The hollow core may be provided with intervening smooth walled sections (without ribs) between the discreet ribbed sections. It is important that the bending zones be sufficient in number and be suitably located along the length of the core so that the core may be bent in the desired manner within the corner locations of the insulated glass assembly.

A spacer core will typically be manufactured as an elongated straight length of tube that will be suitable to be cut into a plurality of spacer sections. That is, a plurality of spacer sections will be cut from a relatively long work piece. In some embodiments, it may be preferable to provide the circumferential ribs along the entire length of each spacer core. It may be preferable in many instances to wind the relatively long work piece on to a spool or other suitable body so that the spacer core may be stored prior to installation within an insulated glass assembly.

Persons skilled in the art will appreciate that there will be other variations and modifications that may be made to provide corrugated, interlocking hollow core spacers. The examples described within this application are not intended to represent all of the possible embodiments of the invention. Indeed, persons skilled in the art will be able to make modified or altered hollow spacer cores and insulated glass assemblies that fall within the scope of the invention. It is intended that such varied and modified products will fall within the scope of the claims of the resulting patent.

1. An elongated tubular spacer core for use in an insulated glass assembly comprising a plurality of bending zones between first and second ends of the core, each bending zone comprising a plurality of circumferential ribs, each rib having sides of unequal length, the ribs being reentrant and overlapping when the core is bent along a longitudinal axis of the core.

2. The core of claim 1 wherein the core is defined by two pairs of opposing parallel walls and a radiused corner between each pair of adjacent walls.

3. The core of claim 2 wherein the walls form a closed hollow tube.

4. The core of claim 3 further comprising one or more composite elements from the group of elements consisting of a desiccant and a vapor barrier.

5. The core of claim 4 wherein the desiccant is provided within the interior of the hollow core.

6. The core of claim 5 defines an elongated hollow tube of sufficient length to provide spacer cores for a plurality of insulated glass assemblies.

7. The core of claim 6 wherein the ribs are identical and extend around the entire perimeter defined by the core.

8. The core of claim 7 wherein the ribs are foldable along a first side of the core and the ribs are extendable along a second opposite side of the core.

9. The core of claim 8 defining an elongated strand reversibly coiled about a rotatable spool.

10. An elongated tubular spacer for use in an insulated glass assembly comprising: an elongated tubular core defining a plurality of ribs extending about the periphery of the tubular core, each rib having sides of unequal length, the ribs folding and overlapping when the core is bent along a longitudinal axis of the core;
a desiccant provided within the interior of the tubular core; and
a vapor barrier provided along the length of the tubular core.

11. An insulated glass assembly comprising:
(a) an elongated tubular spacer comprising an elongated tubular core defining a plurality of ribs extending about the periphery of the tubular core, each rib having sides of unequal length, the ribs folding and overlapping when the core is bent along a longitudinal axis of the core; and
a desiccant provided within the interior of the tubular core;
(b) a vapor barrier provided along the length of the tubular core;
(c) a pair of opposing glass plates;
(d) an adhesive applied to secure the spacer between the pair of opposing glass plates.

12. The tubular spacer of claim 10 wherein the core is defined by two pairs of opposing parallel walls and a radiused corner between each pair of adjacent walls.

13. The tubular spacer of claim 12 wherein the walls form a closed hollow tube.

14. The tubular spacer of claim 13 defines an elongated hollow tube of sufficient length to provide spacer cores for a plurality of insulated glass assemblies.

15. The tubular spacer of claim 12 wherein the ribs are identical and extend around the entire perimeter defined by the core.

16. The tubular spacer of claim 13 wherein the ribs are foldable along a first side of the core and the ribs are extendable along a second opposite side of the core.

17. The glass assembly of claim 11 wherein the core is defined by two pairs of opposing parallel walls and a radiused corner between each pair of adjacent walls.

18. The glass assembly of claim 11 wherein the walls form a closed hollow tube.

19. The glass assembly of claim 11 wherein the ribs are identical and extend around the entire perimeter defined by the core.

20. The glass assembly of claim 19 wherein the ribs are folded along a first side of the core and the ribs are extended along a second opposite side of the core.
